(19) United States
(12) Patent Application Publication
(10) Pub. No.: US 2025/0029281 A1
(43) Pub. Date: Jan. 23, 2025

(54) Depth mapping apparatus

(71) Applicant: APPLE INC., Cupertino, CA (US)

(72) Inventors: Itay Kaufman, Ramat Gan (IL); Aaron Wetzler, Rishon Lezion (IL); Maya Weiss, Givatayim (IL)

(21) Appl. No.: 18/677,940

(22) Filed: May 30, 2024

Related U.S. Application Data
(60) Provisional application No. 63/515,102, filed on Jul. 23, 2023.

(51) Int. Cl. G06T 7/80; G01B 11/22; G01S 17/86; G01S 17/894; G06T 7/593; H04N 13/00; H04N 13/239

(52) U.S. Cl. CPC G06T 7/85; G01B 11/22; G01S 17/86; G01S 17/894; G06T 7/593; H04N 13/239; G06T 2207/30244; H04N 2013/0081

(57) ABSTRACT

A depth mapping apparatus includes a stereoscopic depth mapping module, including a first and second cameras configured to capture pairs of respective first and second images of a scene, and a range-sensing module, configured to measure respective ranges from the apparatus to multiple points in the scene. A controller processes a first pair of the first and second images of the scene to compute a first depth map of the scene and associates at least some of the points at which the range-sensing module measured respective ranges with corresponding pixels in the first depth map. The controller computes a correction function for the stereoscopic depth mapping module by comparing the respective ranges measured by the range-sensing module to respective depth coordinates of the corresponding pixels in the first depth map and applies the correction function in computing subsequent depth maps based on subsequent pairs of the first and second images.

### CROSS-REFERENCE TO RELATED APPLICATION

This application n claims the benefit of U.S. Provisional Patent Application 63/515,102, filed Jul. 23, 2023, whose disclosure is incorporated herein by reference.

### FIELD OF THE INVENTION

The present invention relates generally to systems and methods for depth mapping and visual sensor alignment, and particularly to alignment correction of a sensor stereoscopic depth mapping module.

### BACKGROUND

Various methods are known in the art for optical 3D mapping, i.e., generating a 3D profile of surfaces in a scene by processing optical images of the scene. This sort of 3D profile is also referred to as a 3D map, depth map or depth image, and 3D mapping is also referred to as depth mapping.

Some methods of depth mapping use a stereoscopic approach: Typically, two or more cameras at different positions capture respective images of the scene. A computer analyzes the images to find the relative pixel offset of features of the scene between the two images. The depths of the features are related to the respective pixel offsets.

### SUMMARY

Some embodiments of the present invention that are described hereinbelow provide improved methods for online calibration of stereoscopic depth mapping systems.

There is therefore provided, in accordance with an embodiment of the invention, depth mapping apparatus, which includes a stereoscopic depth mapping module, including a first camera and a second camera having respective first and second optical axes spaced apart by a baseline separation and configured to capture pairs of respective first and second images of a scene. A range-sensing module, is configured to measure respective ranges from the apparatus to multiple points in the scene. A controller is configured to process a first pair of the first and second images of the scene to compute a first depth map of the scene and associate at least some of the points at which the range-sensing module measured respective ranges with corresponding pixels in the first depth map. The controller computes a correction function for the stereoscopic depth mapping module by comparing the respective ranges measured by the range-sensing module to respective depth coordinates of the corresponding pixels in the first depth map and applies the correction function in computing subsequent depth maps based on subsequent pairs of the first and second images.

In a disclosed embodiment, the controller is configured to compare the first and second images in the pair in order to compute an epipolar correction between the first and second cameras, and to apply the epipolar correction in correcting for relative pitch and roll between the first and second cameras.

Additionally or alternatively, the controller is configured to compute the correction function to correct for relative yaw between the first and second cameras. In one embodiment, the controller is configured to compute a first angular disparity between the first and second images at each of the corresponding pixels, to find a second angular disparity at each of the corresponding pixels based on the respective ranges measured by the range-sensing module, and to compute the correction function based on a difference between the first and second angular disparities.

In a disclosed embodiment, the controller is configured to compute the correction function to calibrate a focal length of the stereoscopic depth mapping module. Additionally or alternatively, the controller is configured to compute the correction function to calibrate the baseline separation of the stereoscopic depth mapping module.

In some embodiments, the controller is configured to filter the associated points and the corresponding pixels prior to computing the correction function. In one embodiment, the controller is configured to filter the associated points and the corresponding pixels to remove the points having respective ranges that are outside a predefined distance bound. Alternatively or additionally, the controller is configured to filter the associated points and the corresponding pixels to remove the pixels having a confidence measure below a predefined confidence threshold. Further additionally or alternatively, the controller is configured to filter the associated points and the corresponding pixels to remove the points having respective ranges that differ from the depth coordinates of the corresponding pixels by more than a predefined difference threshold.

In a disclosed embodiment, the range-sensing module includes a Light Detection and Ranging (LiDAR) sensor.

There is also provided, in accordance with an embodiment of the invention, a method for depth mapping, which includes capturing pairs of respective first and second images of a scene using a stereoscopic depth mapping module, including a first camera and a second camera having respective first and second optical axes spaced apart by a baseline separation. Using a range-sensing module, respective ranges to multiple points in the scene are measured. A first pair of the first and second images of the scene is processed to compute a first depth map of the scene. At least some of the points at which the range-sensing module measured respective ranges are associated with corresponding pixels in the first depth map. A correction function is computed for the stereoscopic depth mapping module by comparing the respective ranges measured by the range-sensing module to respective depth coordinates of the corresponding pixels in the depth map. The correction function is applied in computing subsequent depth maps based on subsequent pairs of the first and second images.

The present invention will be more fully understood from the following detailed description of the embodiments thereof, taken together with the drawings in which:

### BRIEF DESCRIPTION OF THE DRAWINGS

FIG. 1 is a schematic pictorial illustration of a depth mapping apparatus, in accordance with an embodiment of the invention;

FIG. 2 is a schematic top view of a stereoscopic depth mapping module in the apparatus of FIG. 1, in accordance with an embodiment of the invention;

FIG. 3 is a flowchart that schematically illustrates a method for generating and correcting a depth map, in accordance with an embodiment of the invention; and

FIGS. 4A-4D are plots that schematically illustrate the impact of yaw correction on depth mapping, in accordance with an embodiment of the invention.

### DETAILED DESCRIPTION OF EMBODIMENTS

### Overview

A stereoscopic depth mapping module comprising a pair of cameras (also referred to as a “stereoscopic pair” hereinbelow) that capture images of the scene provides for depth mapping with high lateral resolution. The lateral resolution may be determined by the projection of the camera pixels onto the scene.

The accuracy of the mapped depth of such a module depends, especially for large depths, on a reliable and accurate adjustment and/or calibration of the relative alignment between the two cameras, to correct for deviations in the relative pitch, roll, and yaw between the cameras, as well as deviations in the baseline separation between the cameras, and the focal length of the camera lenses. This sort of adjustment and calibration can be implemented during the fabrication of the module utilizing depth-mapping targets. However, during the use of the stereoscopic depth mapping module the relative alignment of the stereoscopic pair may change, due to environmental factors characteristic to portable and mobile applications. These environmental factors may include, for example, vibrations, thermal fluctuations, and mechanical shocks. A re-alignment or re-calibration of the module, similar to that implemented during the fabrication, may be infeasible and/or inconvenient in the operating environment. Moreover, the user of the apparatus may not even be aware of the change of the relative alignment of the cameras.

The calibration parameters of a stereoscopic system predominantly influence two types of errors: (1) epipolar error, and (2) disparity error. Epipolar errors are primarily induced by parameters such as pitch, roll, and the vertical location of the optical axis. On the other hand, disparity errors are caused mainly by parameters such as yaw, focal length, horizontal displacement of the optical center, and baseline length. Epipolar errors can be resolved using a synchronized pair of images captured by the system. Disparity errors, however, are more challenging to detect and rectify. Thus, for example, although deviations in the relative pitch and roll of the cameras can be detected and corrected by processing the stereoscopic pair of images, yaw errors are difficult to detect and correct.

To address this problem in the embodiments of the present invention that are described herein, a range-sensing module, such as a Light Detection and Ranging (LiDAR) sensor, is utilized in tandem with the stereoscopic depth mapping module for measuring ranges to points in the scene and correcting the stereoscopic depth measurements as necessary. In alternative embodiments, other types of range-sensing modules may be utilized, or ranges from known points in the scene or from points measured by a global positioning sensor (GPS) may be used. In the embodiments described hereinbelow, both terms “depth” and “range” are used to refer to a distance to the scene, with “depth” used to denote the distance to a given pixel in the stereoscopic depth map, and “range” denoting a distance measured by the LiDAR sensor or other range-sensing module. The term “pixel” refers to lateral (u, v) coordinates in the depth map, as projected onto the (x, y) coordinates in the scene, while the term “point” refers to locations in the scene sampled by the LiDAR sensor. The lateral sampling density by the LiDAR sensor of the points in the scene is typically lower than that of the pixels in the depth m1020ap, but the accuracy of the measured range is higher than that of the mapped depth.

For each pixel in the scene that is imaged by the stereoscopic pair, a depth to that pixel is computed based on the relative lateral shift between the images of the pixel in the two cameras of the stereoscopic pair, the baseline separation of the cameras, and the focal length of the camera lenses. The relative lateral shift is referred to as the linear disparity or “pinhole disparity.” Additionally, in some embodiments, for the purpose of correcting for the relative yaw, a stereoscopic angular disparity is computed, wherein the stereoscopic angular disparity refers to the angular difference between the respective chief rays from a pixel in the scene to the two cameras.

In parallel to or in series with the stereoscopic mapping, the range to multiple points in the scene is measured using the LiDAR sensor. At least some of the points at which the range-sensing module measured respective ranges are associated with corresponding pixels in the first depth map. A correction function is computed for the stereoscopic depth mapping module by comparing the respective ranges measured by the range-sensing module to respective depth coordinates of the corresponding pixels in the depth map. This correction function can then be applied in computing subsequent depth maps based on subsequent pairs of the first and second images.

For purposes of computing the correction function, for example, a LiDAR-based range may be computed from the LiDAR range data for each pixel in the depth map by a suitable interpolation from adjacent LiDAR measurement points. From the interpolated LiDAR range at a pixel, a LiDAR angular disparity for the pixel can computed as though this range were measured with the above stereoscopic pair. The difference between the stereoscopic angular disparity and the LiDAR angular disparity at a pixel in the scene indicates the relative yaw between the two stereoscopic cameras and can thus be used in correcting for the yaw error of the stereoscopic depth mapping module.

For this purpose, in one embodiment, the relative yaws from all pixels are combined to find a single relative yaw, which is then utilized to compute a correction function in the form of a rotation matrix. This rotation matrix is applied to the image sampled by one of the stereoscopic cameras, thus correcting for the relative yaw between the cameras. After the image rotation, i.e., after correcting for the relative yaw, depth maps of the scene are computed using the corrected stereoscopic pair. The correction for the relative yaw between the cameras does not require a physical rotation of either of the cameras, but is rather performed computationally on the images captured by the cameras.

Thus, even when a mechanical shift occurs in the yaw between the cameras, the depth can be calculated correctly without any physical readjustment. This yaw correction process does not require known depth-mapping targets, but rather may be implemented dynamically on a changing scene mapped by the apparatus, thus refining the correction as successive measurements are performed. Moreover, each yaw correction may be performed based on a single data capture by the two range sensing systems.

Thus, some embodiments provide a depth mapping apparatus, comprising a stereoscopic depth mapping module, a range-sensing module, and a controller. The stereoscopic depth mapping module comprises a first camera and a second camera, having respective first and second optical axes spaced apart by a baseline separation, and configured to capture pairs of respective first and second images of a scene. The range-sensing module measures respective ranges from the apparatus to multiple points in the scene. The controller processes a first pair of the first and second images of the scene to compute a first depth map of the scene and associates at least some of the points at which the range-sensing module measured respective ranges with corresponding pixels in the first depth map. The controller computes a correction function for the stereoscopic depth mapping module by comparing the respective ranges measured by the range-sensing module to respective depth coordinates of the corresponding pixels in the depth map. The controller applies the correction function in computing subsequent depth maps based on subsequent pairs of the first and second images.

### System Description

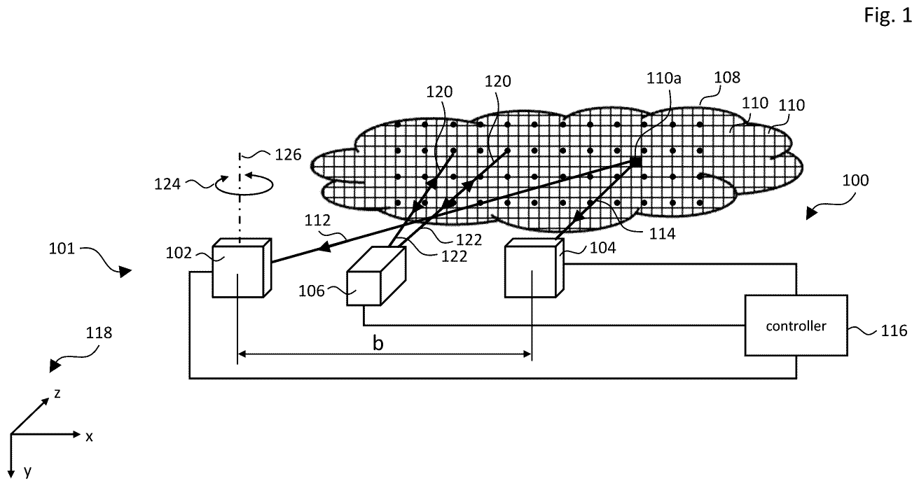

FIG. 1 is a schematic pictorial illustration of a depth mapping apparatus 100, in accordance with an embodiment of the invention.

Depth mapping apparatus 100 comprises a stereoscopic depth mapping module 101, comprising a first camera 102 and a second camera 104, and a range-sensing module, comprising a LiDAR sensor 106. Apparatus acquires and computes a depth map of a scene 108, while correcting for changes in alignment between cameras 102 and 104.

In the present embodiment, LiDAR sensor 106 measures the ranges of points scene 108 by measuring the time of flight of photons to and from these points, in accordance with principles of LiDAR that are known in the art. In alternative embodiments, the range-sensing module may comprise a range sensor other than a LiDAR sensor. Further alternatively, the range data from the scene may be obtained from known points in the scene, or from points measured by a global positioning sensor (GPS).

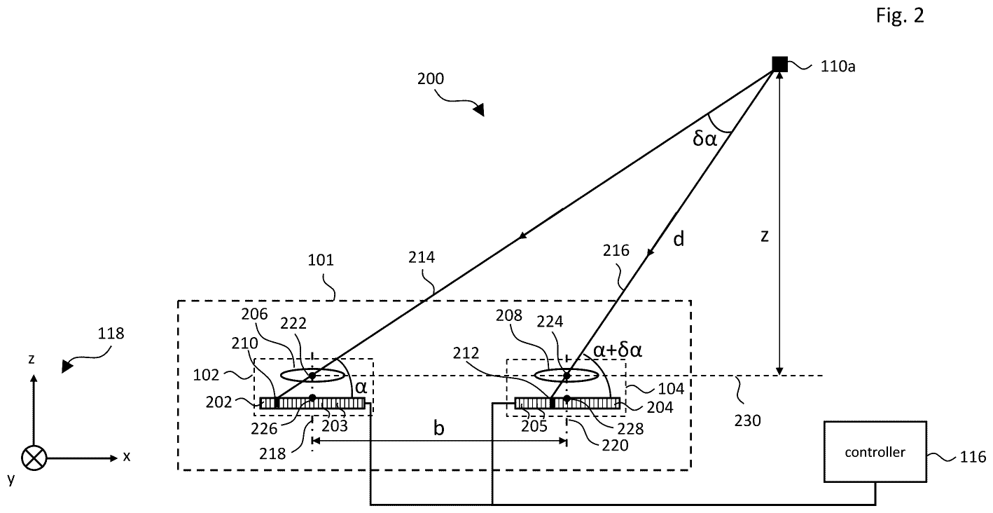

Cameras 102 and 104, comprising pixelated image sensors (as detailed in FIG. 2 hereinbelow), such as CMOS image sensors, capture respective first and second images of scene 108. The sampling of scene 108 is represented by pixels 110, which are projections onto the scene of the pixels of camera 104, used as a reference camera. As an example, the imaging of a pixel 110a to cameras 102 and 104 is depicted schematically by respective rays 112 and 114. (The size of each pixel 110 in FIG. 1 is chosen for convenience of illustration and does not indicate the actual size.) With reference to Cartesian coordinates 118, cameras 102 and 104 are spaced apart in the x-direction by a baseline separation b, with the spacing generating a relative shift in the x-direction of the captured images of scene 108 on the cameras.

A controller 116 is coupled to cameras 102 and 104 and to LiDAR sensor 106. Controller 116 processes the first and second images of scene 108 to compute a depth map of the scene, as will be further detailed hereinbelow. The distance from apparatus 100 to scene 108, predominantly in the z-direction, is typically much larger than the baseline separation b between cameras 102 and 104.

LiDAR sensor 106 measures the range to multiple points 120 in scene 108 by transmitting beams 122 of optical radiation to the points and by sensing portions of the beams reflected back from the scene to the LiDAR. (LiDAR sensor 106 may measure the range using any one of known measurement methods such as time-of-flight (ToF) method or frequency-modulated continuous-wave (FMCW) method.) The array of points 120 is typically sparser than the lateral (x-y) sampling resolution of cameras 102 and 104, i.e., sparser than the pitch of pixels 110 in scene 108. The number of points 120 and their pitch relative to the pitch of pixels 110 is shown schematically only for illustrating the embodiments of the invention. When a specific pixel 110 in the scene does not coincide with one of points 120 sampled by LiDAR 106, a range sensed by the LiDAR may be associated with the specific pixel by interpolating the ranges from surrounding points 120 using bilinear interpolation, for example.

Controller 116 typically comprises a programmable processor, which is programmed in software and/or firmware to carry out the functions that are described herein. Alternatively or additionally, controller 116 comprises hard-wired and/or programmable hardware logic circuits, which carry out at least some of the functions of the controller. Although controller 116 is shown in the figures, for the sake of simplicity, as a single, monolithic functional block, in practice the controller may comprise a single chip or a set of two or more chips, with suitable interfaces for receiving and outputting the signals that t are illustrated in the figures and are described in the text.

When using the stereoscopic pair of cameras 102 and 104 for mapping depths that are much larger than the baseline separation of the cameras, the error in depth is sensitive to the relative yaw between the cameras. In the present description, the term “yaw” refers to a rotational angle around the y-axis, i.e., about the axis in the plane of the cameras that is perpendicular to the baseline between the cameras (x) and to the direction in which the cameras are aimed (z). Specifically, yaw may refer to both the angle of a ray in the xz-plane and the rotation of a camera around the y-axis, with the latter exemplified for camera 102 by a rotation 124 around an axis 126, where the axis is parallel to the y-axis. The term “relative yaw” refers to the difference in the orientation of the cameras around the y-axis. As will be further detailed hereinbelow, the ranges across scene 108 measured by LiDAR sensor 106 are used specifically for correcting the errors in the depth map due to changes in the relative yaw between cameras 102 and 104, thus increasing the accuracy of the depth as mapped by the stereoscopic depth mapping module.

### Stereoscopic Depth Mapping Module

FIG. 2 is a schematic top view 200 of stereoscopic depth mapping module 101 (FIG. 1), in accordance with an embodiment of the invention. For the sake of simplicity, cameras 102 and 104 in view 200 are depicted as comprising image sensors 202 and 204 comprising respective pixels 203 and 205, and thin lenses 206 and 208 having respective lens centers 222 and 224. The dimensions in the drawings are not to scale.

Pixel 110a in scene 108 (FIG. 1) is imaged onto pixels 210 and 212 in respective image sensors 202 and 204. The imaging paths from pixel 110a to the two cameras are denoted by respective chief rays 214 and 216, i.e., by rays from pixel 110a through respective lens centers 222 and 224. (As pixel 110a in scene 108 is a projection of pixel 212 in sensor 204, the image of pixel 110a on sensor 202 does not necessarily land on a single pixel, but may be shared by neighboring pixels of the sensor. For the sake of simplicity, however, we refer to the image on sensor 202 as pixel 210.) Cameras 102 and 104 are spaced apart in the x-direction by the baseline separation b, shown as the distance between respective parallel optical axes 218 and 220 of the two cameras. Due to the baseline separation b, the lateral (x) distances of pixels 210 and 212 from respective detector center points 226 and 228, as well as the angles of chief rays 214 and 216, differ from each other. Either of these differences, referred to as lateral and angular disparities, respectively, may be equivalently utilized for determining the depth d of pixel 110a from stereoscopic depth mapping module 101.

A model known as the “pinhole camera model” utilizes the lateral disparity, denoted by A, between respective image features on the two cameras, such as the lateral disparity between pixels 210 and 212. Introducing the notation of left (L) and right (R) for respective cameras 102 and 104, denoting the x-coordinates of the respective center points 226 and 228 of image detectors 202 and 204 as x_{L}^{C} and x_{R}^{C}, and denoting the x-coordinates of pixels 210 and 212 respectively as x_{L} and x_{R}, the lateral disparity A may be written as

$$Δ = ( {x}_{L} - {x}_{L}^{C} ) - ( {x}_{R} - {x}_{R}^{C} ) . \qquad Eqn . 1$$

Assuming image sensors 202 and 204 to be located at the focal planes of respective lenses 206 and 208, and denoting the focal lengths of the lenses by f, the distance z of pixel 110a from a common plane 230 of the lenses may be computed as

$$z = \frac{fb}{Δ} . \qquad Eqn . 2$$

From Eqn. 2 and the geometry of FIG. 2, depth d from camera 104 (the distance between pixel 110a and lens center 224) may be computed as

$$d = \frac{z}{sin α} . \qquad Eqn . 3$$

For computing the depth map of scene 108, controller 116 extracts from the respective images captured by cameras 102 and 104, using Eqn. 1, the lateral disparity A for each pixel 110. From the lateral disparities across pixels 110, controller 116 utilizes Eqns. 2-3 to compute the depth d for each pixel 110, i.e., the depth map for the scene.

The disparity between the images captured by cameras 102 and 104 can conveniently be expressed in terms of ray angles, rather than linear image positions, even when optical axes of the cameras are not exactly parallel. The space defined by the ray angles is referred to herein as “equidistant disparity space.” From the triangle formed by points 110a, 222, and 224, together with the law of sines, the relationship between the depth d and the angles α and da may be written as

$$\frac{b}{sin ( δα )} = \frac{d}{sin α} , \qquad Eqn . 4$$

wherein α is the angle between chief ray 214 and the x-axis, and δα is the angle between chief rays 214 and 216. (The term δα is referred to as the “stereoscopic disparity angle.”) For the purpose of correcting for the relative yaw of stereoscopic camera pair 102 and 104, further detailed hereinbelow, the stereoscopic disparity angle δα is computed from Eqn. 4 as

$$δα = {sin}^{- 1} ( \frac{d}{b} sin α ) . \qquad Eqn . 5$$

For the use in the yaw correction, the stereoscopic disparity angle δα, as given by Eqn. 5, will be referred to hereinbelow as δα^{stereo}.

### Method for Correction of Camera Misalignment

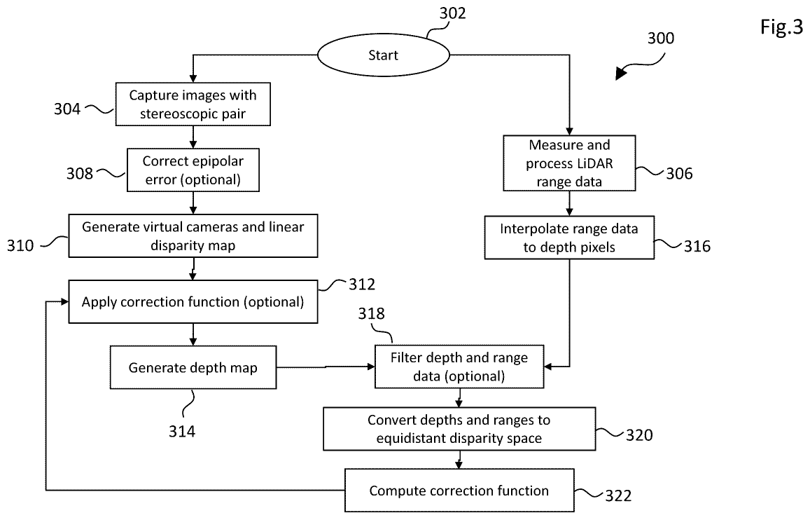

FIG. 3 is a flowchart 300 depicting schematically a method for producing and correcting a depth map using stereoscopic depth mapping module 101 and LiDAR sensor 106, in accordance with an embodiment of the invention. This method may alternatively be applied, mutatis mutandis, using other sorts of range sensors in conjunction with a stereo pair of cameras.

The process starts at a start step 302. First and second stereoscopic images are captured from a scene by two stereoscopic cameras (such as cameras 102 and 104 in FIG. 1) in a stereoscopic image capture step 304. Either simultaneously or sequentially with the image capture, range data is measured by a range sensor (such as LiDAR sensor 106 in FIG. 1) and processed in a LiDAR range measurement and processing step 306. Each of the stereoscopic images comprises M data points, and the LiDAR range data comprises N data points. The lateral (x-y) sampling frequency of the stereoscopic camera pair is typically higher than that of the LiDAR, such that M>>N.

Controller 116 may correct the stereoscopic images captured in step 304 for epipolar misalignment, if so required, in an epipolar correction step 308. Epipolar misalignment includes misalignment of the relative pitch and roll between cameras 102 and 104, and may be corrected for in the captured stereoscopic images using correction algorithms known in the art of stereoscopic vision.

After the optional epipolar correction in step 308, controller 116 generates “virtual cameras” and computes a linear disparity map in a disparity mapping step 310, comprising the following sub-steps:
Compute transformations corresponding to the pitch and roll corrections computed at step 308.
For each camera, apply the transformations to transform the images captured in step 304 from those captured by the real camera to corresponding rectified images captured by corrected “virtual cameras.” The transformed images are termed respectively the “rectified reference frame” and the “rectified auxiliary frame.”
Process the rectified frames by matching corresponding features in the rectified reference and auxiliary frames to compute a linear disparity map {Δⱼ} in the domain of the rectified reference frame, wherein Δⱼ refers to the linear disparity of the j^{th} pixel. The disparity map comprises M values {Δⱼ}, wherein j=1, 2, . . . M enumerates the pixels of the reference camera. Additionally, controller 116 may compute a confidence level map {Uⱼ}, indicating the quality of the match between the features of the reference and auxiliary frames at each pixel and thus the level of confidence in the disparity value at that pixel.

If a correction function for relative yaw between cameras 102 and 104 is available, controller 116 applies it to the rectified auxiliary frame in a correction step 312. The correction function may have the form of a rotation matrix R. The correction function may not be available when the stereoscopic depth mapping module captures an image pair for the first time, in which case step 312 is skipped. The correction function may be stored and applied to subsequent captured images of the scene, or it may be refined following each new scene capture.

In a stereoscopic depth map generation step 314, controller 116 computes a depth map {dⱼ^{stereo}} from the linear disparity map {Δⱼ}. Here dⱼ^{stereo} refers to the depth of the j^{th} pixel.

Following LiDAR range measurement and processing step 306, controller 116 interpolates the range points into the frame of reference of the depth map, in an interpolation step 316. This step comprises the following sub-steps:
Collect the range data as 3-D data points pᵢ, wherein each point refers to Cartesian coordinates (xᵢ, yᵢ, zᵢ), and index i enumerates the N measured LiDAR data points pᵢ, with i=1,2, . . . N. (Points pᵢ are referred to herein as LiDAR-points, although, as described hereinabove, they may be collected using alternative methods.)
Apply a Euclidean transformation to the LiDAR-points pᵢ from the Cartesian coordinates (xᵢ, yᵢ, zᵢ) of the LiDAR to the Cartesian coordinates (xᵢ′, yᵢ′, zᵢ′) of the rectified reference frame, generating points pᵢ′.
Compute for each transformed LiDAR-point pᵢ′ a range dᵢ^{LiDAR} from the point in the scene to the rectified reference frame as dᵢ^{LiDAR}=\sqrt{x′ᵢ²+y′ᵢ²+z′ᵢ²}.
Project each point i to image coordinates (uᵢ, vᵢ) in the pixel coordinate space of the rectified reference frame.
Interpolate the N range data points to M pixels. As the number M of data points captured by the stereoscopic camera pair is much larger than N, the N ranges measured by LiDAR, dᵢ^{LiDAR}, are interpolated to the coordinates of the depth map generated at step 314 and the interpolated data points indexed as dⱼ^{LiDAR}, wherein the index j enumerates, as above, the M pixels in the depth map, j=1, 2, . . . M. The interpolation may be performed using any suitable interpolation method, such as bilinear interpolation. Similarly, image coordinates (uᵢ, vᵢ) of the range measurement points are interpolated to the lateral coordinates of the stereoscopic camera pair, resulting in image coordinates (uⱼ, vⱼ).

Prior to computing the yaw correction function for the depth map, controller 116 optionally filters the depth map generated at step 314 and the interpolated range data generated at step 316, in a filtering step 318. In this step, filtering algorithms may be applied to overcome the following potential problems associated with the depth mapping and range measurement:
LiDAR-noise, wherein processing issues generate noise in the range mapping.
Stereoscopic errors and noise, wherein noise in the visual image and errors in computing the linear disparity may lead to errors in the computed range.
Misalignment, wherein the images between the rectified reference frame and the LiDAR are seriously misaligned.
Occlusion, which may cause the LiDAR sensor and the stereoscopic depth mapping module to measure different depths for the same point in the scene.

In an example embodiment, the filters applied at step 318 comprise the following:
Filter by distance—As each measurement module (stereoscopic and LiDAR) has an optimal measurement distance, the filter may remove any pixels and the associated range data for which either the depth or the range is outside the respective optimal measurement distance. For pixel i with depth or range zᵢ, the pixel is retained only if: {i: min_depth<zᵢ & max_depth>zᵢ}.
Filter by confidence—The filter refers to the confidence level map {Uⱼ} computed at step 308 (as described above), and removes any pixels whose confidence is below a predetermined confidence threshold.
Filter by range and depth difference—In case of occlusion or erroneous alignment between the stereoscopic module and the LiDAR sensor, the respective depth and range measured for one or more pixels may differ from each other. The filter discards any pixel and the associate range data wherein the depth measured by the stereoscopic module differs from the range measured by the LiDAR sensor by more than a predefined difference threshold. For example, for a given threshold percentage T, pixel j may be retained only if:

$$2 \vert \frac{{d}_{j}^{LIDAR} - {d}_{j}^{STEREO}}{{d}_{j}^{LIDAR} + {d}_{j}^{STEREO}} \vert < T / 100$$

In a data conversion step 320, controller 116 converts both the depth map from the stereoscopic depth mapping module and the associated range data from the LiDAR sensor to equidistant angular disparity space for each pixel. The data conversion of step 320 comprises the following sub-steps:
Compute a yaw map {αⱼ} for image coordinates (uⱼ, vⱼ), wherein αⱼ denotes the yaw for the j^{th} pixel:

$${α}_{j} ( {u}_{j} , {v}_{j} ) = \frac{{u}_{j}}{\sqrt{{u}_{j}^{2} + {v}_{j}^{2}}} {tan}^{- 1} \sqrt{{u}_{j}^{2} + {v}_{j}^{2}} . \qquad Eqn . 6$$

The values of uⱼ and vⱼ are relative to the center of the depth map and are normalized by the effective focal length of the camera.
Compute an effective LiDAR angular disparity δαⱼ^{LiDAR} in the equidistant angular space of the yaw map:

$${δα}_{j}^{LIDAR} = {sin}^{- 1} ( \frac{b}{{d}_{j}^{LIDAR}} sin {α}_{j} ) , \qquad Eqn . 7$$

where αⱼ is the yaw from Eqn. 6, b is the baseline separation of the pair of stereoscopic cameras (FIG. 2), and dⱼ^{LiDAR} is the LiDAR range interpolated to the pixels as previously described. δαⱼ^{LiDAR} is equal to the stereoscopic angular disparity that would yield the LiDAR range dⱼ^{LiDAR} for the j^{th} pixel.
Compute the stereoscopic angular disparity δαⱼ^{stereo} for each pixel j using Eqn. 5:

$${δα}_{j}^{stereo} = {sin}^{- 1} ( \frac{b}{d} sin {α}_{j} ) . \qquad Eqn . 8$$

In correction function step 322, controller 116 computes a correction function for the relative yaw by comparing the LiDAR and stereoscopic angular disparities given by equations 7 and 8 for each of the pixels in the scene. The difference between the two angular disparities for each point j across the scene, δαⱼ^{LiDAR}-δαⱼ^{stereo}, is due to the relative yaw between the two stereoscopic cameras 102 and 104. In the equidistant angular space, this difference should be uniform over the entire depth map. Thus, controller 116 may estimate relative yaw ϵ as a median of the disparity differences:

$$ϵ = Median ( {δα}_{j}^{LIDAR} - {δα}_{j}^{stereo} ) , \qquad Eqn . 9$$

wherein the median is computed over all pixels j, j=1,2, . . . M.

Based on the relative yaw E, controller 116 computes a rotation matrix R, representing a rotation around the y-axis by the amount ϵ (taking into account the sign of ϵ). This rotation matrix R is used subsequently in correction step 312 to correct for the yaw error of stereoscopic depth mapping module 101.

In alternative embodiments, controller 116 estimates the relative yaw ϵ using other functions, such as an optimization algorithm of the form:

$${argmin}_{ϵ} {Σ}_{j} \vert ϵ - {δα}_{j}^{LIDAR} + {δα}_{j}^{stereo} \vert , \qquad Eqn . 10$$

wherein the function argmin selects the value for e such that the sum of the absolute values over the pixels j is minimized.

As depth mapping apparatuses (such as apparatus 100) are commonly used for continuous depth mapping of a changing scene, the correction function computed at step 322 may be applied in many successive depth maps generated by stereoscopic depth mapping module 101. Periodically, the process depicted in flowchart 300 is repeated, starting from step 302, to repeat both the range measurement and to update the correction functional.

In an additional embodiment, errors in the focal length f and baseline b (FIG. 2) may be estimated to calibrate and correct for variations in these two parameters. This kind of estimation and calibration is valuable, as certain conventional optimization algorithms utilized in stereoscopic imaging encounter numerical difficulties in distinguishing between errors due to yaw ϵ, baseline b, and focal length f, due to their high correlation. These parameters may be numerically separated utilizing the following optimization:

$${argmin}_{ϵ , b , f} {Σ}_{j} \vert ϵ - {sin}^{- 1} ( \frac{b}{{d}_{j}^{LIDAR}} sin {α}_{j} ) + {sin}^{- 1} ( \frac{{Δ}_{j}}{f} {( sin {α}_{j} )}^{2} ) \vert . \qquad Eqn . 11$$

### Results of Yaw Correction

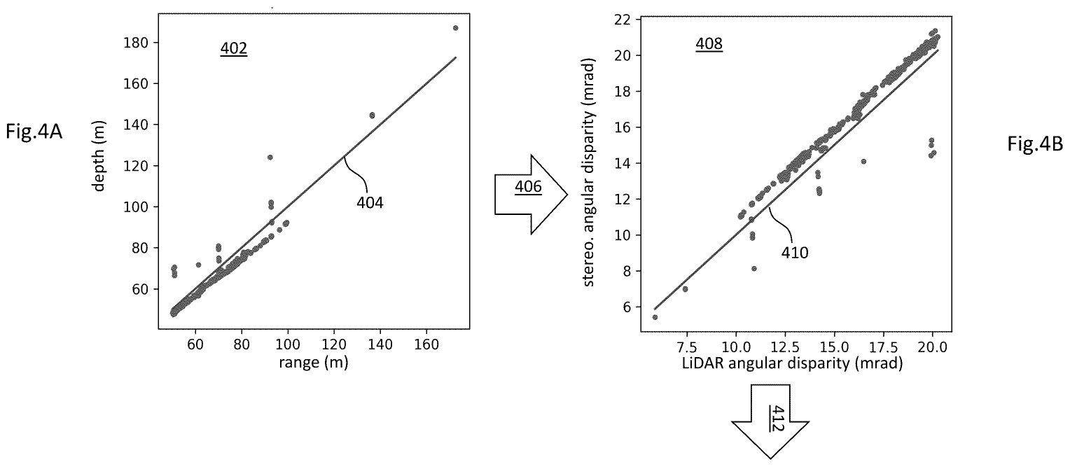

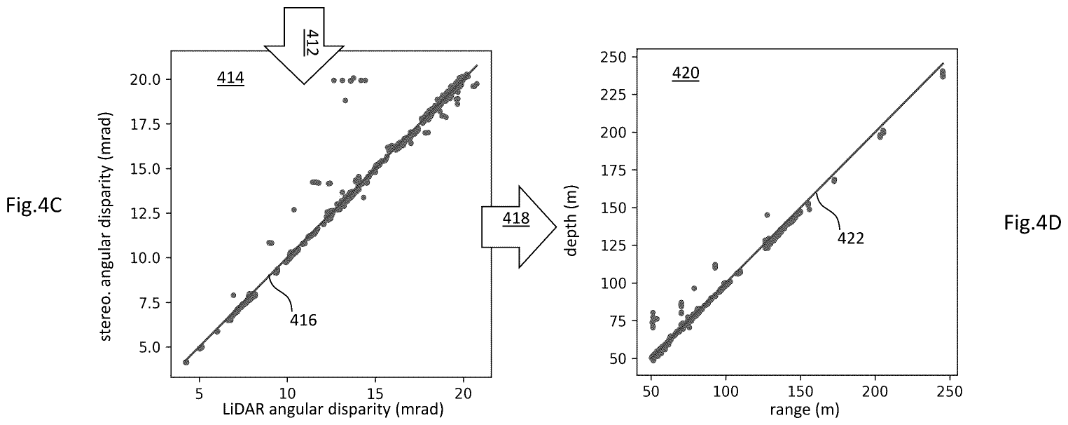

FIGS. 4A-4D are plots that schematically illustrate the impact of yaw correction on depth mapping, in accordance with an embodiment of the invention.

The data in the plots of FIGS. 4A-D comprises depth and range data, as well as respective angular disparities collected by a depth mapping apparatus comprising both a stereoscopic depth mapping module and a LiDAR sensor, such as apparatus 100 (FIG. 1). The data is processed as described in flowchart 300 in FIG. 3 and shown before and after relative yaw correction.

Each data point in a plot 402 in FIG. 4A refers to a pixel in a scene (such as a pixel 110 in scene 108 of FIG. 1). The horizontal axis shows the range for the pixel as measured by the LiDAR sensor of the apparatus, and the vertical axis shows the depth for the pixel as measured by the stereoscopic depth mapping module of the apparatus, before correcting for relative yaw. The range values of the data points have been computed as in steps 306 and 316 of flowchart 300, and depth values have been computed as in steps 304, 308, 310, and 314 (with correction step 312 skipped). Data points, at which the respective range and depth values differed by more than a predefined difference threshold were filtered out of the plot.

A line 404 represents ideal performance of the apparatus, in which stereoscopic depth mapping module 101 and LiDAR sensor 106 give equal values at each point in the scene. A noticeable discrepancy is seen between line 404 and the data points, indicating a mismatch between the range and the depth of the data points.

An arrow 406 indicates the conversion of the depth and range data to stereoscopic and LiDAR angular disparities, as performed in step 320 of flowchart 300. The resulting data points are shown in a plot 408 in FIG. 4B, in which the horizontal axis shows the LiDAR angular disparity, and the vertical axis shows the stereoscopic angular disparity. A line 410 again represents ideal performance, in which the angular disparities are equal, and brings out the discrepancy in the data points.

An arrow 412 indicates the re-computation of the stereoscopic disparity after correcting apparatus 100 for relative yaw, as detailed in flowchart 300. The resulting plot 414 in FIG. 4C comprises a much larger number of points than either of plots 402 and 408: Due to correction of relative yaw, many of the data points that were earlier discarded due to differing range and depth values now have range and depth values sufficiently close to warrant their inclusion. The stereoscopic and LiDAR angular disparities are roughly equal, falling on a line 416 over the entire range.

An arrow 418 indicates a conversion of the corrected stereoscopic and LiDAR angular disparities to respective depth and range data, shown by a plot 420 in FIG. 4D. The data points fall roughly along a line 422, showing good agreement between the depth and range values over a large span of distances.

It will be appreciated that the embodiments described above are cited by way of example, and that the present invention is not limited to what has been particularly shown and described hereinabove. Rather, the scope of the present invention includes both combinations and various features subcombinations of the described hereinabove, as well as variations and modifications thereof which would occur to persons skilled in the art upon reading the foregoing description and which are not disclosed in the prior art.

1. A depth mapping apparatus, comprising:
a stereoscopic depth mapping module, comprising a first camera and a second camera having respective first and second optical axes spaced apart by a baseline separation and configured to capture pairs of respective first and second images of a scene;
a range-sensing module, configured to measure respective ranges from the apparatus to multiple points in the scene; and
a controller configured to:
process a first pair of the first and second images of the scene to compute a first depth map of the scene;
associate at least some of the points at which the range-sensing module measured respective ranges with corresponding pixels in the first depth map;
compute a correction function for the stereoscopic depth mapping module by comparing the respective ranges measured by the range-sensing module to respective depth coordinates of the corresponding pixels in the first depth map; and
apply the correction function in computing subsequent depth maps based on subsequent pairs of the first and second images.

2. The apparatus according to claim 1, wherein the controller is configured to compare the first and second images in the pair in order to compute an epipolar correction between the first and second cameras, and to apply the epipolar correction in correcting for relative pitch and roll between the first and second cameras.

3. The apparatus according to claim 1, wherein the controller is configured to compute the correction function to correct for relative yaw between the first and second cameras.

4. The apparatus according to claim 3, wherein the controller is configured to compute a first angular disparity between the first and second images at each of the corresponding pixels, to find a second angular disparity at each of the corresponding pixels based on the respective ranges measured by the range-sensing module, and to compute the correction function based on a difference between the first and second angular disparities.

5. The apparatus according to claim 1, wherein the controller is configured to compute the correction function to calibrate a focal length of the stereoscopic depth mapping module.

6. The apparatus according to claim 1, wherein the controller is configured to compute the correction function to calibrate the baseline separation of the stereoscopic depth mapping module.

7. The apparatus according to claim 1, wherein the controller is configured to filter the associated points and the corresponding pixels prior to computing the correction function.

8. The apparatus according to claim 7, wherein the controller is configured to filter the associated points and the corresponding pixels to remove the points having respective ranges that are outside a predefined distance bound.

9. The apparatus according to claim 7, wherein the controller is configured to filter the associated points and the corresponding pixels to remove the pixels having a confidence measure below a predefined confidence threshold.

10. The apparatus according to claim 7, wherein the controller is configured to filter the associated points and the corresponding pixels to remove the points having respective ranges that differ from the depth coordinates of the corresponding pixels by more than a predefined difference threshold.

11. The apparatus according to claim 1, wherein the range-sensing module comprises a Light Detection and Ranging (LiDAR) sensor.

12. A method for depth mapping, comprising:
using a stereoscopic depth mapping module, comprising a first camera and a second camera having respective first and second optical axes spaced apart by a baseline separation, capturing pairs of respective first and second images of a scene;
using a range-sensing module, measuring respective ranges to multiple points in the scene;
processing a first pair of the first and second images of the scene to compute a first depth map of the scene;
associating at least some of the points at which the range-sensing module measured respective ranges with corresponding pixels in the first depth map;
computing a correction function for the stereoscopic depth mapping module by comparing the respective ranges measured by the range-sensing module to respective depth coordinates of the corresponding pixels in the depth map; and
applying the correction function in computing subsequent depth maps based on subsequent pairs of the first and second images.

13. The method according to claim 12, wherein processing the first pair of the first and second images comprises comparing the first and second images in the pair in order to compute an epipolar correction between the first and second cameras, and applying the epipolar correction in correcting for relative pitch and roll between the first and second cameras.

14. The method according to claim 12, wherein computing the correction function comprises correcting for relative yaw between the first and second cameras.

15. The method according to claim 14, wherein computing the correction function comprises computing a first angular disparity between the first and second images at each of the corresponding pixels, finding a second angular disparity at each of the corresponding pixels based on the respective ranges measured by the range-sensing module, and calculating the correction function based on a difference between the first and second angular disparities.

16. The method according to claim 12, wherein computing the correction function comprises calibrating a focal length of the stereoscopic depth mapping module.

17. The method according to claim 12, wherein computing the correction function comprises calibrating the baseline separation of the stereoscopic depth mapping module.

18. The method according to claim 12, and comprising filtering the associated points and the corresponding pixels prior to computing the correction function.

19. The method according to claim 18, wherein filtering the associated points and the corresponding pixels comprises removing the points having respective ranges that differ from the depth coordinates of the corresponding pixels by more than a predefined difference threshold.

20. The method according to claim 12, wherein the range-sensing module comprises a LiDAR sensor.
